(19) United States
(12) Patent Application Publication
(10) Pub. No.: US 2019/0220582 A1
(43) Pub. Date: Jul. 18, 2019

(54) BIOMETRICALLY AUTHORISABLE DEVICE

(71) Applicant: ZWIPE AS, Oslo (NO)

(72) Inventor: Kim Kristian HUMBORSTAD, Oslo (NO)

(21) Appl. No.: 16/312,940

(22) PCT Filed: Jun. 21, 2017
(86) PCT No.: PCT/EP2017/065282

§ 371 Date: Dec. 21, 2018

(30) Foreign Application Priority Data
Jun. 29, 2016 (GB) 1611308.6
Feb. 9, 2017 (GB) 1702141.1

(51) Int. Cl. G06F 21/32; H04L 29/06; G06F 21/62; G06Q 20/40

(52) U.S. Cl. CPC G06F 21/32; G06Q 20/40145; G06F 21/6245; H04L 63/0861

(57) ABSTRACT

A method for enrolment of biometric data to a biometrically authorisable device (102) is described. The method comprises: using a configuration system (24) for configuration of software and/or hardware on the biometrically authorisable device (102). The configuration system (24) receives biometric data for a user (22) from a mobile device (28), the configuration system (24) being remote from the mobile device (28) and communicating with the mobile device via a data transmission network (26). The mobile device (28) is a device known to the user and previously used by the user for secure or personal communication, for example a smartphone (28). The configuration system (24) enrols the biometric data to the biometrically authorised device (102) and provides personalisation data to the biometrically authorisable device (102). The personalisation data acts to personalise the device (102) to the user (22) and includes user specific data intended to be accessible during later use of the biometrically authorisable device (102) in response to biometric authorisation using the pre-enrolled biometric data and a biometric sensor of the biometrically authorisable device (102). The biometrically authorisable device (102) is sent to the user (22) only when both the biometric data has been enrolled and the personalisation data has been added.

The present invention relates to a method, a computer programme product and a system for enrolling biometric data onto a biometrically authorisable device, as well as to biometric devices produced by such enrolment.

Biometric authorised devices such as fingerprint authorised smartcards are becoming increasingly more widely used. Smartcards for which biometric authorisation has been proposed include, for example, access cards, credit cards, debit cards, pre-pay cards, loyalty cards, identity cards, and so on. Smartcards are electronic cards with the ability to store data and to interact with the user and/or with outside devices, for example via contactless technologies such as RFID. These cards can interact with sensors to communicate information in order to enable access, to authorise transactions and so on. Other devices are also known that make use of biometric authorisation such as fingerprint authorisation, and these include computer memory devices, building access control devices, military technologies, vehicles and so on.

Although the use of biometric data creates obvious opportunities for improved security, there are also disadvantages in relation to the added complexity for the user and the provider of the biometrically authorised device. The user's biometric data must be obtained and then enrolled to the device. There is a potential security issue in relation to the recordal of and transmission of biometric data. One proposal is for the device to be capable of enrolling biometric data directly to the biometrically authorisable device, which means that the biometric data can in theory be kept from leaving the device, and also the user never passes their biometric data to a third party.

Examples of this type of a device are found in WO2016/055665 and in US 2013/207786, both of which utilise fingerprint sensors. In each of these documents a biometrically authorisable device is described in which both of the enrolment of fingerprint data and the later authorisation of the user make use of the sensor on the device itself.

However, whilst there are benefits the use of self-enrolment also imposes additional constraints on the biometrically authorised device, since whatever system is used for sensing biometrics must additionally be capable of enrolling new biometric data if the device is to operate in such a fashion. This can require, for example, a sensor with better resolution or larger size, and/or greater level of electrical power might be needed. In the case of a fingerprint as the biometric data it is common to permit identification of a user based on a partial fingerprint, whereas enrolment typically requires a full fingerprint and repeated scans of the fingerprint in order to create a full fingerprint ‘template’ for later authentication of the user's identity. Thus, it is not always ideal to use the same sensor for enrolment as for authorisation.

Viewed from a first aspect, the invention provides a method for enrolment of biometric data to a biometrically authorisable device, the method comprising: using a configuration system for configuration of software and/or hardware on the biometrically authorisable device; the configuration system receiving biometric data for a user from a mobile device, the configuration system being remote from the mobile device and communicating with the mobile device via a data transmission network, and the mobile device being a device known to the user and previously used by the user for secure or personal communication; enrolling the biometric data to the biometrically authorisable device using the configuration system; providing personalisation data to the biometrically authorisable device using the configuration system, the personalisation data acting to personalise the device to the user and including user specific data intended to be accessible during later use of the biometrically authorisable device in response to biometric authorisation using the pre-enrolled biometric data and a biometric sensor of the biometrically authorisable device; and then sending the biometrically authorisable device to the user only when both the biometric data is enrolled and the personalisation data is added.

With this method the user's mobile device is used to obtain biometric data, which is sent to the configuration system and then enrolled onto the biometrically authorisable device. The user does not need to interact with an unknown device in relation to the biometric enrolment. For example they are not required to go to a bank or other company that might be issuing the biometric authorisable device. The method may further include the steps carried out at the mobile device. Hence, in some examples the method for enrolment of biometric data to a biometrically authorisable device, the method utilises: a mobile device with a biometric sensor, the mobile device being accessible to a user being a device known to the user and being a device previously used by the user for secure or personal communication; a data transmission network in communication with the mobile device, the data transmission network being able to receive biometric data from the mobile device; and the configuration system; the method comprising: obtaining biometric data from the user via the mobile device; transmitting the biometric data to the configuration system via the data transmission network; enrolling the biometric data to the biometrically authorised device using the configuration system; providing personalisation data to the biometrically authorisable device using the configuration system, the personalisation data acting to personalise the device to the user and including user specific data intended to be accessible during later use of the biometrically authorisable device in response to biometric authorisation using the pre-enrolled biometric data and a biometric sensor of the biometrically authorisable device; and then sending the biometrically authorisable device to the user only when both the biometric data is enrolled and the personalisation data is added.

With these methods, in contrast to the known “self-enrolling” devices referenced above, the biometric data is enrolled to the device before personalisation and using a different sensor to the sensor on the device. Self-enrolled devices are personalised before they are delivered to the user and this creates problems in relation to secure transport of the devices, as well as a need for reliable self-enrolment protocols. Biometric sensors on such devices can sometimes have restrictions on size and power usage, and both of these factors mean that it may be difficult to provide high quality self-enrolment systems. The method of the first aspect makes use of a biometric sensor on a separate mobile device, rather than requiring enrolment via the biometric sensor of the biometrically authorisable device. This reduces or removes restrictions on the sensor used for enrolment and hence increases both the accuracy of the enrolment and also the design freedom for the biometrically authorisable device. In some examples the biometrically authorisable device is not capable of self-enrolment, i.e. the device is not provided with the necessary software and/or hardware for enrolment of biometric data to the device.

Preferably, the personalisation data is provided to the biometrically authorisable device only after the biometric data has been enrolled. When the biometric data is enrolled to the device prior to personalisation, then the user specific data on the device is always secured with the biometric data. Indeed, in example embodiments after the device has been configured then even the operator of the configuration system is unable to access the personalisation data without biometric authorisation from the user. In some embodiments the biometrically authorisable device does not contain any sensitive or secure data concerning the user prior to enrolment of the biometric data. In one example the biometrically authorisable device is devoid of all personal data concerning the user prior to enrolment of the biometric data.

The biometric sensor of the biometrically authorisable device may be a sensor for obtaining fingerprint data such as a camera or a dedicated fingerprint sensor (e.g. a contact area type fingerprint sensor). In this context both a camera and a dedicated fingerprint sensor are seen as “fingerprint sensors”. The biometric data may hence be fingerprint data. The mobile device may therefore be used to obtain fingerprint data via a camera or a dedicated fingerprint sensor. It should be noted that it is not required to use the same kind of sensor at the mobile device for enrolment as at the biometrically authorisable device for checking the identity of the user. In fact there may be advantages in using different sensor types. For example, a fingerprint area sensor may be easily implemented with low thickness and low power usage, which can be highly important where the biometrically authorisable device is a smartcard. However, where the mobile device is a smartphone then there is often a readily available high quality camera, with the inclusion of and quality of a fingerprint sensor being a lesser priority for smartphone manufacturers.

In the case of fingerprint biometrics the end user typically enrols a fingerprint (as used herein, fingerprint also encompasses a thumbprint) by scanning it multiple times across the fingerprint sensor or presenting it to a fingerprint sensor camera until multiple images are captured. For example some systems require five or more images, such as ten images. The multiple fingerprint images are combined to form a composite template file, which hence forms the fingerprint data for transmission to the configuration system. It should be noted that advantageously although the fingerprint template file will allow the identity of the user to be checked via fingerprint recognition it does not involve supplying a copy of the fingerprint itself to the configuration system. The fingerprint is hence protected and in a sense it does not leave the user's possession. The present method may make use of any suitable algorithm to produce the fingerprint data, such as the fingerprint template, and this may be executed at the mobile device, or optionally on another processing device that is linked to the data transmission network. The fingerprint data may be encrypted prior to transmission to the configuration system.

Where non-fingerprint biometrics are used (e.g. facial recognition) then a similar feature may be present, in which a biometric template is sent to the configuration system rather than sending more complete details of the user's biometrics. Thus, the data sent in the form of the biometric template may permit reliable confirmation of the user's identify without allowing fraudulent copying of the user's biometrics.

Once the configuration system receives the biometric data from the mobile device, such as the fingerprint template file in the above example, then it enrols the data to the biometrically authorisable device. For example, where the device is a smartcard used for payments this may include saving the biometric data to the Secure Element on the smartcard. The operator of the configuration system will then use the configuration system to personalise the biometrically authorisable device by providing the personalisation data. For example, with a smartcard used for payments this might include assigning the account number, such as the typical sixteen-digit account number for credit cards, as well as possibly other details such as the end user's name, billing/mailing address, and so on. For other types of devices and smartcards with alternative/additional functions then other personalisation data might be added, such as identification numbers or codes used for access to areas of a building or access to vehicle entry systems. It is preferred that after the biometric data is enrolled to the device then the operator of the configuration system permanently deletes the biometric data.

The mobile device could be any device accessible to the user and having a suitable biometric sensor, i.e. a sensor able to gather the required biometric data. The enrolment process could for example involve a mobile computer device, including a laptop, tablet or smartphone, and this might be a device accessible to the user at a location remote from the configuration system. In preferred implementations the mobile device is a device that is already in the user's possession and/or is already known to the user before they apply for the biometrically authorised device and/or before they are approved to be issued with the biometrically authorised device. Thus, the user has a greater degree of control in relation to handling of their biometric data compared to prior art systems where the user must provide a biometric sample directly to the issuer of the biometrically authorisable device. Advantageously the mobile device is a trusted device, i.e. a device known to and previously used by the user for secure or personal communications.

One example that is expected to be widely used is for the mobile device with the biometric sensor to be the user's smartphone, the smartphone including a biometric sensor in the form or a camera and/or a fingerprint sensor. A smartphone camera can be used to obtain biometric data in the form of images of the user for facial recognition and/or to obtain biometric data in the form of fingerprint data for fingerprint recognition. Examples of software for obtaining fingerprint biometrics from a camera such as a smartphone camera include: ONYX® software supplied by Diamond Fortress Technologies of Birmingham, Ala., USA; OnePrint® supplied by IDair of Huntsville, Ala.; and BioSSL Fingerprint verification products supplied by BioSSL Ltd. of Wellington, United Kingdom. A dedicated fingerprint sensor may provide an alternative or additional way to obtain fingerprint data via a smartphone. The biometric data sent out of the smartphone and to the configuration system may be a fingerprint template or facial recognition template rather than the original image data or fingerprint scan data in order to avoid external transmission of complete details of the user's biometrics.

The use of the user's smartphone allows the method to make use of a device that is well known to the user and readily available to them, and this may also be a device where the user has previously gone through a biometric enrolment process and/or may use other biometric security software. When the method makes use of the user's smartphone and fingerprint data as the mobile device and the biometric data then the process is fully trusted by the user and the incidence of problems with enrolment can be minimised.

The method may include providing instructions to the user to guide enrolment via the biometric sensor on the mobile device. This will minimize any difficulty with enrolment of fingerprint data and will enable enrolment and hence use of the protected device with minimal delay. For example, the user may be provided with feedback during the process of gathering biometric data, and/or instructions on how to interact with the biometric sensor. In the example of a smartphone as the mobile device the method may include the use of a smartphone application (“App”) to provide instructions to the user. The operator of the configuration system can offer an App to be downloaded from their website or from an App store such as Google Playstore.

Considering again the possible use of fingerprint biometrics, when a fingerprint sensor is used then the instructions to the user might include guidance and/or feedback relating to the location of the fingerprint on the fingerprint sensor and/or to the pressure applied. When a camera is used then the instructions to the user might include guidance and/or feedback relating to the framing of the fingerprint in the field of view of the camera, the distance to the camera and/or lighting levels. The instructions may include advising the user on a number of repeats required to complete the biometric enrolment, for example the number of successful fingerprint scans that are still needed. If an App is used then once the biometric enrolment process is completed successfully the App may securely transmit the biometric data to the configuration system via the data transmission network. As noted above, this may be as biometric template data and in that case the App may be arranged to produce a suitable template, such as a fingerprint template.

In one particular example, using a smartphone as the mobile device, a fingerprint as the biometric and a smartcard for payments as the biometrically authorised device, then a smartcard issuer such as a bank can offer an App to users that are approved for issuance of the smartcard. The end user is provided with a secure, reliable tool that may be integrated into the bank's secure network and provides instructions for the enrolment process. Once installed, the App will guide the end user to use the smartphone camera as a fingerprint sensor or to use a dedicated fingerprint sensor integrated into the smartphone to enrol their fingerprint data. The fingerprint data (preferably as a template) is sent via the data transmission network to the configuration system, which in this case can be operated by the bank/smartcard issuer. The fingerprint data is enrolled to the smartcard and then the personalisation data is added.

Advantageously the method includes sending the biometrically authorisable device to the enrolled user after personalisation. This may be done via mail or courier service, for example. Once the user receives the biometrically authorisable device then it is already enrolled, so the device may be used immediately. The device therefore cannot be used fraudulently if it is intercepted during delivery.

The operator of the configuration system may be the issuer of the device, such as a bank as mentioned above. This means that the issuer of the device retains control of the personalisation process, which can be done with the same security protocols as similar existing processes, and they also have control of the biometric enrolment process, which again can be treated in a suitably secure fashion. However, the user maintains control of their own biometric, which is obtained via the user's mobile device, and in preferred implementations the configuration system does not have access to the full biometric data, but instead may receive only a template or the like. Only the mobile device and the configuration system need have access to the biometric data, and this enhances the security of the process.

The issuer of the biometrically authorised device may receive a blank device from the manufacturer, or a partially assembled/partially completed device. In one example the biometrically authorised device is encapsulated after the enrolment of biometric data and the addition of the personalisation data, thus providing a mechanical protection against fraud. For example a smartcard may be provided to the issuer of the device prior to a lamination step, with electronic connections/electrical components used for enrolment being exposed, and then after enrolment of the biometric data the issuer of the device may carry out lamination with this sealing the electronic connections/electrical components used for enrolment and preventing further access without physical tampering with the device. Alternatively the enrolment and/or personalisation may be done via a secure wireless data connection with the biometrically authorised device.

The data transmission network may include networks used for mobile telephone communications and/or the internet. The biometric data should of course be transmitted securely and so preferably the communication over the data transmission network is secure communication. The secure communication may be implemented using conventional methods, for example including encryption of the biometric data.

In later use of the biometrically authorised device, after the authorised user has enrolled their biometric data with the biometrically authorised device in accordance with the method above, the user may then typically be required to go through a biometric authentication process via the biometric sensor on the device in order to authorise some or all uses of the biometrically authorised device, in particular to access functions needing the use of the personalisation data. The biometric authentication process may be carried out in any suitable way, such as techniques used for conventional biometric sensors including fingerprint sensors. In the case of fingerprints the user may need to place their finger or thumb on a fingerprint sensor of the biometrically authorised device. A fingerprint matching algorithm in the control system may be used to identify a fingerprint match between an enrolled user and a fingerprint sensed by the fingerprint sensor. In the event of a failure to match the fingerprint, the control system may issue a prompt for a non-fingerprint authorisation.

The biometrically authorisable device may require authorisation for each time the user requires access to some or all functions. Alternatively, or for other functions, the device may require only a periodic authorisation, with other uses of the device being permitted without checking the user's identity. Thus, the device might be useable in a similar way to existing “chip & PIN” cards for contactless transactions, where the PIN is not required for every transaction provided that the PIN is used with sufficient frequency to confirm that the authorised user has retained control of the card.

It is preferred for the biometrically authorised device to be arranged so that it is impossible to extract the biometric data used for identifying users once it has been enrolled. The biometric data may be encrypted and accessible only to the processor of the device, for example.

Viewed from a second aspect, the invention provides a configuration system for configuration of software and/or hardware on a biometrically authorisable device, wherein the configuration system is arranged to communicate with a data transmission network in order to receive biometric data from a mobile device that is remote from the configuration system; wherein the configuration system is arranged to enrol the biometric data to the biometrically authorised device and to provide personalisation data to the biometrically authorisable device, the personalisation data acting to personalise the device to the user and including user specific data; and wherein the configuration system does not release the biometrically authorisable device for sending to the user until both the biometric data is enrolled and the personalisation data is added.

The configuration system may be a part of a broader system for enrolment of biometric data to a biometrically authorisable device, the system including: a mobile device with a sensor for obtaining biometric data, the mobile device being accessible to a user, being a device known to the user and being a device previously used by the user for secure or personal communication; a data transmission network in communication with the mobile device, the data transmission network able to receive biometric data from the mobile device; and the configuration system; wherein the mobile device is arranged to obtain biometric data from the user and to then transmit the biometric data to the configuration system via the data transmission network; wherein the configuration system is arranged to enrol the biometric data to the biometrically authorised device and to provide personalisation data to the biometrically authorisable device using the configuration system, the personalisation data acting to personalise the device to the user and including user specific data; wherein the configuration system does not release the biometrically authorisable device for sending to the user until both the biometric data is enrolled and the personalisation data is added; and wherein the biometrically authorisable device is arranged to provide access to some or all of the personalisation data during later use of the biometrically authorisable device, with access being permitted in response to biometric authorisation using the pre-enrolled biometric data and a biometric sensor of the biometrically authorisable device.

These systems provides similar advantages to the methods described above and the biometrically authorisable device, the data transmission network and/or the configuration system may be arranged to operate as described above.

The configuration system may be arranged to provide the personalisation data only after the biometric data is enrolled to the biometrically authorised device. In some examples the biometrically authorisable device is not capable of self-enrolment, i.e. the device is not provided with the necessary software and/or hardware for enrolment of biometric data to the device.

The biometric sensor may be a sensor for obtaining fingerprint data such as a camera used as a fingerprint sensor or a dedicated fingerprint sensor (e.g. a fingerprint area sensor). The biometric data may hence be fingerprint data. As noted above, although the same biometric needs to be used the mobile device and the biometrically authorisable device may have a different type of sensor for sensing that biometric.

The configuration system is arranged to receive the biometric data and then enrol the data to the biometrically authorisable device. For example, where the device is a smartcard used for payments this may include saving the biometric data to a memory associated with the processor on the smartcard. The configuration system is arranged to personalise the biometrically authorisable device by providing the personalisation data only after the enrolment of the biometric data has been completed. The personalisation data can be as discussed above.

The mobile device could be as described above, and one example that is expected to be widely used is for the mobile device with the biometric sensor to be the user's smartphone, the smartphone including a fingerprint sensor implemented via the camera of the smartphone or as a dedicated fingerprint sensor.

The mobile device can be arranged to provide instructions to the user to guide enrolment via the biometric sensor on the mobile device. Where the device is a smartphone then the smartphone may include an App as discussed above.

In the method or the system described above, the biometrically authorisable device may include any of the features discussed below. The biometrically authorisable device may include a biometric processor for executing a biometric matching algorithm and a memory for storing biometric data for one or more enrolled user(s). The control system of the biometrically authorisable device may include multiple processors, wherein the biometric processor may be a separate processor associated with the fingerprint sensor. Other processors may include a control processor for controlling basic functions of the device, such as communication with other devices (e.g. via contactless technologies), activation and control of receivers/transmitters, activation and control of secure elements such as for financial transactions and so on. The various processors could be embodied in separate hardware elements, or could be combined into a single hardware element, possibly with separate software modules.

The biometrically authorisable device may be a portable device, by which is meant a device designed for being carried by a person, preferably a device small and light enough to be carried conveniently. The device can be arranged to be carried within a pocket, handbag or purse, for example. The device may be a smartcard such as a fingerprint authorisable RFID card. The device may be a control token for controlling access to a system external to the control token, such as a one-time-password device for access to a computer system or a fob for a vehicle keyless entry system. The device is preferably also portable in the sense that it does not rely on a wired power source. The device may be powered by an internal battery and/or by power harvested contactlessly from a reader or the like, for example from an RFID reader.

The biometrically authorisable device may be a single-purpose device, i.e. a device for interacting with a single external system or network or for interacting with a single type of external system or network, wherein the device does not have any other purpose. Thus, the device is to be distinguished from complex and multi-function devices such as smartphones and the like.

Where the biometrically authorisable device is a smartcard then the smartcard may be any one of: an access card, a credit card, a debit card, a pre-pay card, a loyalty card, an identity card, or the like. The smartcard preferably has a width of between 85.47 mm and 85.72 mm, and a height of between 53.92 mm and 54.03 mm. The smartcard may have a thickness less than 0.84 mm, and preferably of about 0.76 mm (e.g. ±0.08 mm). More generally, the smartcard may comply with ISO 7816, which is the specification for a smartcard.

Where the biometrically authorisable device is a control token it may for example be a keyless entry key for a vehicle, in which case the external system may be the locking/access system of the vehicle and/or the ignition system. The external system may more broadly be a control system of the vehicle. The control token may act as a master key or smart key, with the radio frequency signal giving access to the vehicle features only being transmitted in response to biometric identification of an authorised user. Alternatively the control token may act as a remote locking type key, with the signal for unlocking the vehicle only being able to be sent if the biometric authorisation identifies an authorised user. In this case the identification of the authorised user may have the same effect as pressing the unlock button on prior art keyless entry type devices, and the signal for unlocking the vehicle may be sent automatically upon fingerprint or non-fingerprint identification of an authorised user, or sent in response to a button press when the control token has been activated by authentication of an authorised user.

The biometrically authorisable device may be capable of wireless communication, such as using RFID or NFC communication. Alternatively or additionally the device may comprise a contact connection, for example via a contact pad or the like such as those used for “chip and pin” payment cards. In various embodiments, the biometrically authorised device may be capable of both wireless communication and contact communication.

In yet a further aspect, the present invention provides a computer programme product for enrolment of biometric data to a biometrically authorisable device, the computer programme product comprising instructions that, when executed on a configuration system for configuration of software and/or hardware on the biometrically authorisable device, will cause the configuration system to: receive biometric data for a user from a mobile device that is a device known to the user and previously used by the user for secure or personal communication, the configuration system being remote from the mobile device and communicating with the mobile device via a data transmission network; enrol the biometric data to the biometrically authorised device using the configuration system; provide personalisation data to the biometrically authorisable device, the personalisation data acting to personalise the device to the user and including user specific data intended to be accessible during later use of the biometrically authorisable device in response to biometric authorisation using the pre-enrolled biometric data and a biometric sensor of the biometrically authorisable device; and to release the biometrically authorisable device for sending to the user only when the biometric data is enrolled and the personalisation data is added.

The computer programme product may be arranged to cause the configuration system to behave in accordance with any of the features described above in connection with the method of the first aspect.

The invention further extends to a biometrically authorisable device produced by the method or system described above. The biometrically authorisable device has a biometric sensor and includes enrolled biometric data along with personalisation data, wherein the biometric data has been obtained via a mobile device that is separate to the biometrically authorisable device, and the biometrically authorisable device is arranged to provide access to some or all of the personalisation data during later use of the biometrically authorisable device, with access being permitted in response to biometric authorisation using the pre-enrolled biometric data and the biometric sensor of the biometrically authorisable device.

This biometrically authorisable device can have any of the features discussed above in connection with the biometrically authorisable device used in the method and system described above. The biometrically authorisable device may include biometric data that has been enrolled to the device prior to addition of the personalisation data. The device may be incapable of self-enrolment, and in some examples the biometrically authorisable device is not provided with the necessary software and/or hardware for enrolment of biometric data to the device. The biometric data may be fingerprint data captured via a smartphone sensor, such as fingerprint template obtained from multiple fingerprint scans from a smartphone fingerprint sensor or a smartphone camera. The biometrically authorisable device may be a smartcard with a fingerprint sensor. The fingerprint sensor on the biometrically authorisable device may differ in size and/or type from the sensor of the mobile device that was used to obtain the fingerprint data stored on the device for use in authorisation of access by one or more enrolled user(s). For example, the sensor of the mobile device may be a camera whereas the sensor on the biometrically authorisable device may be a fingerprint area sensor such as a capacitive type sensor.

Certain preferred embodiments on the present invention will now be described in greater detail, by way of example only and with reference to the accompanying drawings, in which:

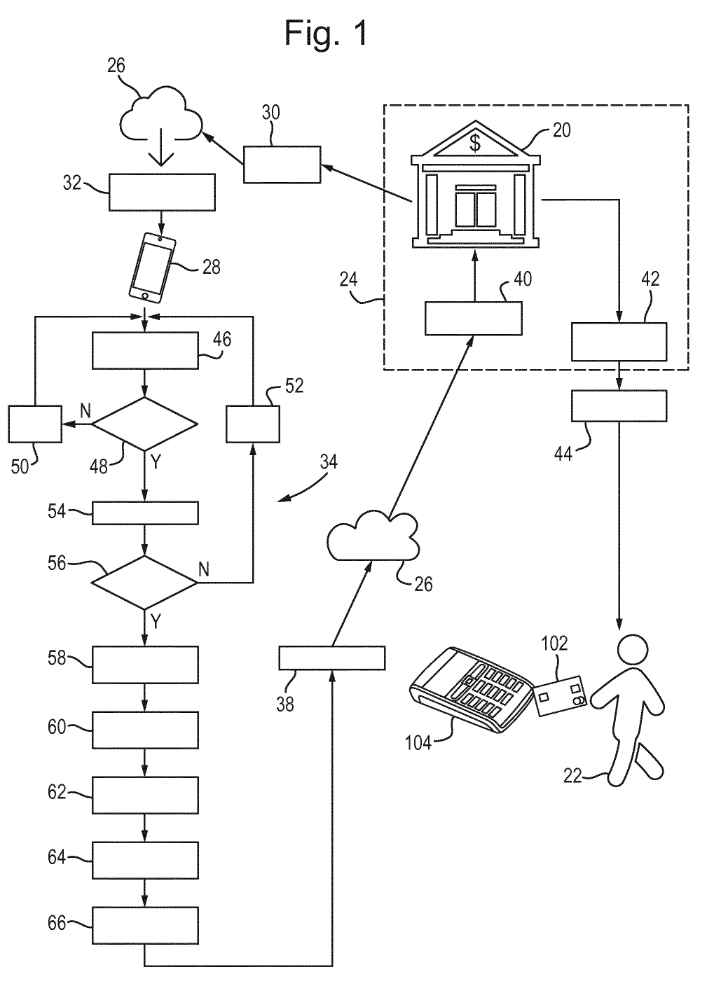

FIG. 1 is a diagram of a system for enrolment of biometric data to a biometrically authorised device; and

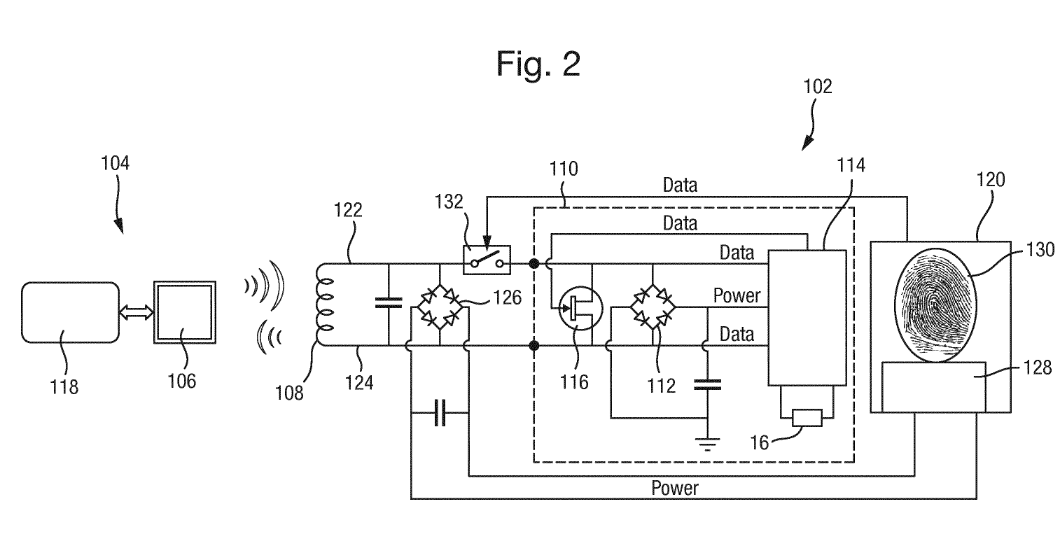

FIG. 2 shows an example schematic for a smartcard with a fingerprint sensor.

By way of example the invention is described in the context of a fingerprint authorised smartcard 102 that includes contactless technology and uses power harvested from a card reader 104. These features are envisaged to be advantageous features of one application of the proposed enrolment method and system, especially in view of the wide availability of suitable sensors on mobile devices that are already possessed by many potential users of biometrically authorised devices. It is however important to understand that these features of the preferred embodiment are not seen as essential features. The same enrolment method might be applied without any substantial change to other biometrically authorised devices, such as a control token as mentioned above. A different type of biometric data may be used in place of fingerprint data. A smartcard may alternatively use a physical contact and/or include a battery providing internal power.

In accordance with an example a bank 20 decides to issue a fingerprint protected smartcard 102 to a user 22. FIG. 1 shows various steps of the method of enrolment of the fingerprint data. The smartcard 102 might be as described below in connection with FIG. 2. The bank 20 operates a configuration system 24 that is represented schematically by the dashed lines enclosing the steps performed at the configuration system 24. This would typically be physically located at a site controlled by the bank and might include computer devices for communication with the smartcard 102 and capable of interacting with other computer devices at the bank 20. The configuration system 24 is also in communication with a data transmission network (such as the internet 26) in order to allow communication with a mobile device 28, which in this case is a smartphone 28 having a fingerprint sensor (not shown).

The basic steps for enrolling fingerprint data to the smartcard 102 are as follows. The bank 20 provides an app to the consumer at step 30, for example via the internet 26. At step 32 the consumer 22 downloads the App to their smartphone 28. The App could be made generally available to any consumer 22, hence being ready to use at such point as when the consumer 22 is authorised for issuance of a smartcard 102 by the bank 20. Alternatively, the bank might choose to only provide a link to the App to customers when issuance of the smartcard 102 has been authorised, thereby making the software effectively “invitation only”. Different versions of the software might be provided for different operating systems and different smartphones, as is well known in relation to smartphone applications.

Once installed on the smartphone 28 the App guides the user 22 through a fingerprint enrolment process as illustrated in FIG. 1 in the flow chart 34. This is explained in more detail below. The fingerprint enrolment process 34 produces a composite template file, which is transmitted at step 38 to the configuration system 24 via a data transmission network, which may again be the Internet 26. The configuration system 24 receives the composite template file 38 at step 40 and then carries out an enrolment and personalisation process 42 where in a first step the fingerprint data is enrolled to the card 102 and then in a second step, after the first step, personalisation data is added to the card 102. Thus, in this example the bank receives the Composite Template File and saves it to the Secure Element on the end user's payment card, as well as then personalising the card by assigning the sixteen-digit account number, the end user's name, billing/mailing address, and so on. Once the fingerprint data is enrolled and the card is personalized, the bank will permanently delete the Composite Template File.

Only after both the fingerprint data is enrolled to the card 102 and the personalisation data is added to the card 102 is the card then sent to the user 22, as depicted at step 44. The bank 20 thus mails the smartcard 102 when it has pre-enrolled biometric protection as well as having the typical personalisation data. As soon as the end user 22 retrieves the card 102 from the mailbox or other delivery mechanism then the card is usable. If the payment card 102 is lost in the mail, any illicit attempts to use the card 102 will not work because the miscreant who attempts to fraudulently use it will be unable to since the biometric authorisation is already enabled. For the payment cards that successfully arrive with the end user, it is not necessary for the end user to activate the card by calling a toll-free number or logging into a website. The card is biometrically protected and immediately useable by the rightful owner without risk of fraudulent use if the card is intercepted.

There are also advantages from the use of the smartphone 28 during the enrolment process, since the smartphone 28 is better able to present information and instructions to the user 22 than would be the case if the smartcard 102 was used for “self enrolment” as in the prior art referenced above.

The App will guide the end user 22 to use the camera of the smartphone 28 or the fingerprint sensor integrated into the smartphone 28 in the fingerprint enrolment process 34. For instance, the end user 22 may be instructed to use software for capturing a fingerprint template using the camera as a fingerprint sensor. Examples of software for obtaining fingerprint biometrics from a camera such as a smartphone camera include: ONYX® software supplied by Diamond Fortress Technologies of Birmingham, Ala., USA; OnePrint® supplied by IDair of Huntsville, Ala.; and BioSSL Fingerprint verification products supplied by BioSSL Ltd. of Wellington, United Kingdom. This software could be adapted in accordance with the current invention, or alternative software with a similar function could be used. In either event the instructions for enrolment would be consistent with best use of the software.

Alternatively the end user 22 may enrol a finger by scanning it multiple times across the fingerprint sensor on the smartphone 28, for example until ten images are captured. These are stored as a Composite Template File for transmission to the bank 20 via steps 38 and 40. With the use of a dedicated fingerprint sensor the user 22 is instructed to place their finger on the sensor at step 46, and the sensor attempts to detect the finger at step 48. If the finger is not detected on the sensor then the App can tell the user to rescan as depicted by feedback 50. If fingerprint is captured at step 54 then the quality of the fingerprint scan is checked at step 56. If the end user 22 applied too much pressure on one of the scans, the mobile app will tell the end user 22 to rescan, using less pressure, as shown at step 52. The fingerprint is processed into a template file at step 58, and the process is repeated at step 60. When a certain number (for example ten) of successful scans are gathered then at step 62 a Composite Template File is made. The Composite Template File is encrypted at step 64, and the App then will congratulate the end user on successful enrolment and request the end user to upload the Composite Template File onto the bank's secure server at step 66. The enrolment via the configuration system 20 at the bank then proceeds as above.

FIG. 2 shows the architecture of a smartcard 102 that can be enrolled using the proposed method, and may hence be used as the smartcard 102 within the system of FIG. 1. A powered card reader 104 transmits a signal via an antenna 106. The signal is typically 13.56 MHz for MIFARE® and DESFire® systems, manufactured by NXP Semiconductors, but may be 125 kHz for lower frequency PROX® products, manufactured by HID Global Corp. This signal is received by an antenna 108 of the smartcard 102, comprising a tuned coil and capacitor, and then passed to a communication chip 110. The received signal is rectified by a bridge rectifier 112, and the DC output of the rectifier 112 is provided to processor 114 that controls the messaging from the communication chip 110.

A control signal output from the processor 114 controls a field effect transistor 116 that is connected across the antenna 108. By switching on and off the transistor 116, a signal can be transmitted by the smartcard 102 and decoded by suitable control circuits 118 in the sensor 104. This type of signalling is known as backscatter modulation and is characterised by the fact that the sensor 104 is used to power the return message to itself.

An accelerometer 16, which is an optional feature, is connected in an appropriate way to the processor 114. The accelerometer 16 can be a Tri-axis Digital Accelerometer as provided by Kionix, Inc. of Ithaca, N.Y., USA and in this example it is the Kionix KXCJB-1041 accelerometer. The accelerometer senses movements of the card and provides an output signal to the processor 114, which is arranged to detect and identify movements that are associated with required features on the card as discussed below. The accelerometer 16 may be used only when power is being harvested from the powered card reader 104, or alternatively the smartcard 102 may be additionally provided with a battery (not shown in the Figures) allowing for the accelerometer 16, and also the related functionalities of the processor 114 and other features of the device to be used at any time.

The smartcard further includes a fingerprint authentication engine 120 including a fingerprint processor 128 and a fingerprint sensor 130. This allows for authorisation via fingerprint identification. The fingerprint processor 128 can advantageously be incapable of enrolment of fingerprint data, thus ensuring that the smartcard 102 must be enrolle via another method, which is preferably enrolment pre-personalisation using enrolment data from a mobile device. The fingerprint processor 128 and the processor 114 that controls the communication chip 110 together form a control system for the device. The two processors could in fact be implemented as software modules on the same hardware, although separate hardware could also be used. As with the accelerometer 16 (where present) the fingerprint sensor 130 may be used only when power is being harvested from the powered card reader 104, or alternatively the smartcard 102 may be additionally provided with a battery (not shown in the Figures) allowing power to be provided at any time for the fingerprint sensor 130 and fingerprint processor 128, as well as the processor 114 and other features of the device.

The antenna 108 comprises a tuned circuit including an induction coil and a capacitor, which are tuned to receive an RF signal from the card reader 104. When exposed to the excitation field generated by the sensor 104, a voltage is induced across the antenna 108.

The antenna 108 has first and second end output lines 122, 124, one at each end of the antenna 108. The output lines of the antenna 108 are connected to the fingerprint authentication engine 120 to provide power to the fingerprint authentication engine 120. In this arrangement, a rectifier 126 is provided to rectify the AC voltage received by the antenna 108. The rectified DC voltage is smoothed using a smoothing capacitor and then supplied to the fingerprint authentication engine 120.

The fingerprint sensor 130 of the fingerprint authorisation engine, which can be an area fingerprint sensor 130, may be mounted on a card housing or fitted so as to be exposed from a laminated card body 140. The card housing or the laminated body 140 encases all of the components of FIG. 2, and is sized similarly to conventional smartcards. The fingerprint authentication engine 120 can be passive, and hence is powered only by the voltage output from the antenna 108. The processor 128 comprises a microprocessor that is chosen to be of very low power and very high speed, so as to be able to perform fingerprint matching in a reasonable time.

The fingerprint authentication engine 120 is arranged to scan a finger or thumb presented to the fingerprint sensor 130 and to compare the scanned fingerprint of the finger or thumb to the pre-stored fingerprint data using the processor 128. A determination is then made as to whether the scanned fingerprint matches the pre-stored fingerprint data. In a preferred embodiment, the time required for capturing a fingerprint image and authenticating the bearer of the card 102 is less than one second.

If a fingerprint match is determined, then the processor takes appropriate action depending on its programming. In this example the fingerprint authorisation process is used to authorise the use of the smartcard 104 with the contactless card reader 104. Thus, the communication chip 110 is authorised to transmit a signal to the card reader 104 when a fingerprint match is made. The communication chip 110 transmits the signal by backscatter modulation, in the same manner as the conventional communication chip 110. The card may provide an indication of successful authorisation using a suitable indicator, such as a first LED 136.

1. A method for enrolment of biometric data to a biometrically authorisable device, the method comprising:
using a configuration system for configuration of software and/or hardware on the biometrically authorisable device;
the configuration system receiving biometric data for a user from a mobile device, the configuration system being remote from the mobile device and communicating with the mobile device via a data transmission network, and the mobile device being a device known to the user and previously used by the user for secure or personal communication;
enrolling the biometric data to the biometrically authorisable device using the configuration system;
providing personalisation data to the biometrically authorisable device using the configuration system, the personalisation data acting to personalise the device to the user and including user specific data intended to be accessible during later use of the biometrically authorisable device in response to biometric authorisation using the pre-enrolled biometric data and a biometric sensor of the biometrically authorisable device; and
sending the biometrically authorisable device to the user only when both the biometric data is enrolled and the personalisation data is added.

2. A method as claimed in claim 1, including providing instructions to the user to guide enrolment via a sensor on the mobile device.

3. A method as claimed in claim 1 or 2, wherein the personalisation data is provided to the biometrically authorisable device only after the biometric data has been enrolled.

4. A method as claimed in claim 1, 2 or 3, wherein the biometrically authorisable device does not contain any sensitive or secure data concerning the user prior to enrolment of the biometric data.

5. A method as claimed in any preceding claim, wherein the personalisation data includes one or more of an identification number, account number, the end user's name and the end user's billing/mailing address.

6. A method as claimed in any preceding claim, the method comprising:
utilising a mobile device with a sensor for obtaining biometric data, the mobile device being accessible to the user, a data transmission network in communication with the mobile device, the data transmission network being able to receive biometric data from the mobile device, and the configuration system;
obtaining biometric data from the user via the sensor of the mobile device;
transmitting the biometric data to the configuration system via the data transmission network;
enrolling the biometric data to the biometrically authorised device using the configuration system;
providing personalisation data to the biometrically authorisable device using the configuration system, the personalisation data acting to personalise the device to the user and including user specific data intended to be accessible during later use of the biometrically authorisable device in response to biometric authorisation using the pre-enrolled biometric data and a biometric sensor of the biometrically authorisable device; and
sending the biometrically authorisable device to the user only when both the biometric data is enrolled and the personalisation data is added.

7. A method as claimed in claim 6, wherein the sensor of the mobile device is a dedicated fingerprint sensor or a camera for obtaining fingerprint data, the biometric sensor of the biometrically authorisable device is a fingerprint sensor, and the biometric data is fingerprint data.

8. A method as claimed in claim 6 or 7, wherein the mobile device is a trusted device that is already in the user's possession and/or already known to the user before they apply for the biometrically authorised device and/or before they are approved to be issued with the biometrically authorised device.

9. A method as claimed in claim 6, 7 or 8, wherein the mobile device with the biometric sensor is the user's smartphone.

10. A method as claimed in claim 9, including using a smartphone application to provide instructions to the user to guide enrolment of the user's fingerprint via the smartphone.

11. A method as claimed in claim 10, wherein the instructions to the user include guidance and/or feedback relating to the location of the fingerprint relative to the sensor of the smartphone.

12. A configuration system for configuration of software and/or hardware on a biometrically authorisable device; wherein the configuration system is arranged to communicate with a data transmission network in order to receive biometric data from a mobile device that is remote from the configuration system; wherein the configuration system is arranged to enrol the biometric data to the biometrically authorised device and to provide personalisation data to the biometrically authorisable device, the personalisation data acting to personalise the device to the user and including user specific data; and wherein the configuration system does not release the biometrically authorisable device for sending to the user until both the biometric data is enrolled and the personalisation data is added.

13. A system for enrolment of biometric data to a biometrically authorisable device, the system including:
a mobile device with a sensor for obtaining biometric data, the mobile device being accessible to a user being a device known to the user and being a device previously used by the user for secure or personal communication;
a data transmission network in communication with the mobile device, the data transmission network able to receive biometric data from the mobile device; and
the configuration system of claim 12;
wherein the mobile device is arranged to obtain biometric data from the user and to then transmit the biometric data to the configuration system via the data transmission network;
wherein the configuration system is arranged to enrol the biometric data to the biometrically authorised device and to provide personalisation data to the biometrically authorisable device using the configuration system, the personalisation data acting to personalise the device to the user and including user specific data;
wherein the configuration system does not release the biometrically authorisable device for sending to the user until both the biometric data is enrolled and the personalisation data is added; and
wherein the biometrically authorisable device is arranged to provide access to some or all of the personalisation data during later use of the biometrically authorisable device, with access being permitted in response to biometric authorisation using the pre-enrolled biometric data and a biometric sensor of the biometrically authorisable device.

14. A system as claimed in claim 13 wherein the biometrically authorisable device, the data transmission network and/or the configuration system are arranged to operate as claimed in any of claims 1 to 11.

15. A system as claimed in claim 13 or 14, wherein the mobile device is the user's smartphone, the biometric data is fingerprint data, and biometrically authorisable device hence includes a fingerprint sensor.

16. A system as claimed in claim 13, 14 or 15, wherein the mobile device is arranged to provide instructions to the user to guide enrolment via the sensor on the mobile device.

17. A system as claimed in any of claims 13 to 16, wherein the biometrically authorisable device is a portable device, by which is meant a device designed for being carried by a person.

18. A system as claimed in any of claims 13 to 16, wherein the biometrically authorisable device is a smartcard including any one of: an access card, a credit card, a debit card, a pre-pay card, a loyalty card, or an identity card.

19. A computer programme product for enrolment of biometric data to a biometrically authorisable device, the computer programme product comprising instructions that, when executed on a configuration system for configuration of software and/or hardware on the biometrically authorisable device, will cause the configuration system to:
receive biometric data for a user from a mobile device that is a device known to the user and previously used by the user for secure or personal communication, the configuration system being remote from the mobile device and communicating with the mobile device via a data transmission network;
enrol the biometric data to the biometrically authorised device using the configuration system;
provide personalisation data to the biometrically authorisable device, the personalisation data acting to personalise the device to the user and including user specific data intended to be accessible during later use of the biometrically authorisable device in response to biometric authorisation using the pre-enrolled biometric data and the biometric sensor of the biometrically authorisable device; and
to release the biometrically authorisable device for sending to the user only when the biometric data is enrolled and the personalisation data is added.

20. A computer programme product as claimed in claim 19 comprising instructions that, when executed on a configuration system for configuration of software and/or hardware on the biometrically authorisable device, will cause the configuration system to behave in accordance with any of claims 1 to 11.

21. A biometrically authorisable device produced by the method of claims 1 to 11 or the system of claims 12 to 18.

22. A biometrically authorisable device comprising a biometric sensor and including enrolled biometric data along with personalisation data, wherein the biometric data has been obtained via a mobile device that is separate to the biometrically authorisable device, and the biometrically authorisable device is arranged to provide access to some or all of the personalisation data during later use of the biometrically authorisable device, with access being permitted in response to biometric authorisation using the pre-enrolled biometric data and the biometric sensor of the biometrically authorisable device.

23. A biometrically authorisable device as claimed in claim 22, comprising biometric data that has been enrolled to the device prior to addition of the personalisation data.

24. A biometrically authorisable device as claimed in claim 22 or 23, wherein biometrically authorisable device is incapable of self-enrolment.

25. A biometrically authorisable device as claimed in claim 22, 23 or 24, wherein the biometric sensor is a fingerprint sensor and the biometric data is fingerprint data captured via a smartphone.

26. A biometrically authorisable device as claimed in any of claims 22 to 25, wherein the biometric sensor is a fingerprint sensor and the biometrically authorisable device is a smartcard.
